(19) United States
(12) Patent Application Publication
(10) Pub. No.: US 2025/0117269 A1
(43) Pub. Date: Apr. 10, 2025

(54) DATA MANAGEMENT, AGGREGATION, AND RECONCILIATION SYSTEMS AND METHODS

(71) Applicant: Provable Recursion B.V., Amsterdam (NL)

(72) Inventors: Matthew Rainey Cohen, New York, NY (US); Ruben de Vries, Amsterdam (NL); Mátyás Lipták, Amsterdam (NL)

(21) Appl. No.: 18/892,196

(22) Filed: Sep. 20, 2024

Related U.S. Application Data
(60) Provisional application No. 63/696,709, filed on Sep. 19, 2024.
(60) Provisional application No. 63/584,303, filed on Sep. 21, 2023.

(51) Int. Cl. G06F 9/54; G06F 21/62

(52) U.S. Cl. CPC G06F 9/546; G06F 21/6209; G06F 2209/547

(57) ABSTRACT

Various embodiments provide for an intermediary system and architecture that can operate under the communication constraints imposed by controller/clearance systems, and can also adapt respective data model and data services to accommodate functionality constraints. Further embodiments are configured to expand conventional functionality of the architecture, including enhancements to track user information beyond the operations provided by any clearing/controller system, and further manage a plurality of communication formats and/or architectures on behalf of a plurality of systems and communication standards, including custom messaging formats. Other embodiments are configured to resolve technical constraints of conventional approaches (e.g., infrastructure of overnight securities lending). Conventional data models are configured to capture information and reconcile on a day-to-day basis. This creates a vast gulf in tracking operations and managing data over a period greater than one day. New data architectures and data models are implemented to resolve this challenge.

### RELATED APPLICATIONS

This Application claims priority under 35 U.S.C. § 119 to U.S. Provisional Application Ser. No. 63/584,303, entitled “DATA MANAGEMENT, AGGREGATION, AND RECONCILIATION SYSTEMS AND METHODS” filed Sep. 21, 2023. This Application claims priority under 35 U.S.C. § 119 to U.S. Provisional Application Ser. No. 63/696,709, entitled “SYSTEMS AND METHODS FOR INTEROPERABILITY AND DATA VERIFICATION” filed Sep. 19, 2024. Each of which is incorporated by reference herein in their entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

A variety of participants and participant systems cooperate in securities exchange and lending. Conventional securities lending suffers from inefficient architectures, limited compatibility, and constraints imposed by system participants given regulatory authority. Securities lending, for example, has a high barrier to entry limited to parties with heavily documented legal relationships, bilateral risk management and credit oversight, disparate and delayed accounting and heavy infrastructure costs and predominantly over the counter (OTC) bilateral party to party lending operations. Conventional bilateral securities lending processes is tied to the use of a settlement depository (often referred to as a Central Securities Depository or “CSD”), such as the Depository Trust and Clearing Corporation's (“DTCC”) subsidiary the Depository Trust Company (“DTC”) and their associated systems (e.g., clearing or controller systems).

Recently new authorities have entered the architecture in the form of the Depository Trust and Clearing Corporation (DTCC). The DTCC, as with other CCP and CSD's have been instrumental in the automation, centralization, standardization, and streamlining of the activity in the financial markets. Until recently, its principal role has been as a CCP in conjunction with the role of providing settlement services for the buy and sell activity of Securities through the NSCC and DTC entities respectively.

### SUMMARY

In conventional approaches, security clearance or controller systems (e.g., the DTCC) are configured to limit access to and operations for participation in the Securities Finance Transaction (“SFT”) Clearing Service to approved SFT Submitters, and further imposes a required communication format for any submission. In one example, such submissions must meet the NSCC Uniform Trade Capture (“UTC”) requirements, and furthermore they then must communicate under the Depository Trust Company's (“DTC”) Settlement and Asset Services (“SAS”) requirements. The communication protocols are rigidly enforced and are constrained to specific data. These limitations facilitate operation at the controller or clearance systems; however, the same constraints prevent functionality in the architecture and increase the burden on participant systems to reconcile and validate secure and consistent data operation. Overall, the constraints create technical barriers to efficient execution and often require custom solutions on participant systems.

The inventors have realized that there is a need for an intermediary system and architecture that can operate under the technical and communication constraints imposed, adapt the data model used by the clearing or control system to improve functionality in the system architecture and improve data services to track user information beyond the constrained functionality provided by any controller or clearing system (e.g., CCP (e.g., NSCC)), and manage communication formats and/or architectures on behalf of a plurality of systems and communication standards, even custom messaging formats.

According to one embodiment, a data management and data aggregation system can operate as an intermediary between users and even their respective trading systems/trading platforms to provide transparent access to any vertically integrated clearing and settlement system (e.g., the DTCC) or an individual CCP (e.g., the Options Clearing Corporation or the OCC) working with an independent settlement system (e.g. DTC) for securities lending activity or other linked loan-style markets. In some embodiments, the intermediary system can include application programming interfaces (APIs) that are configured to accept and communicate information via a first user format, manage translations of the first user format into an any standardized communication format (e.g., NSCC UTC/DTC SAS format), and enable tracking of clearing data provided by any clearing system (e.g., NSCC) over time, an example of functionality that conventional system (e.g., the DTCC) implementation does not provide. In some embodiments, the APIs are configured to respective participant systems or platforms, so that the intermediary system provides a host of APIs each tailored to native operation formats associated with respective systems.

The inventors have also realized that another technical flaw/challenge is presented based on the implementation of the infrastructure of overnight securities lending. The data model captures information and reconciles on a day-to-day basis. This results in such clearing pools (e.g., the NSCC) treating operations and clearing execution on a daily basis with no knowledge or tracking of time continuity past a single day. Stated generally, under the data architecture and data model implemented, each lend or borrow operation lasts one day and expires, putting the onus on the client systems to track data having durations greater than one day. Under such architectures, the clients' systems have the burden/challenge of tracking the operations of various clearing systems (including, for example, the NSCC) over time.

In various embodiments, the intermediary system is configured to resolve the architecture problem and link client based information to newly created day-to-day information generated by clearing system (e.g., NSCC) operation and/or confirmation messages received from the respective clearing system (e.g., NSCC). According to one example, because the NSCC's UTC is the recipient of an aggregated single source of truth via an Approved SFT Submitter, and subsequently arbiter of valid information in this architecture, all participants must comply and under conventional implementation accept the constraints imposed. However, the intermediary system can enhance functionality and operations by managing and linking the data provided to a more robust data model, and in further example, manage a variety of communication architectures used by connected users and/or systems. According to some embodiments, the system is configured to manage the tracking and various communication architectures to provide transparent data management and eliminate the complexities and resolve tracking issues presented by the architectures that are in place.

According to one aspect, a system for extending data management (e.g., for maintaining inventory of exchangeable instruments) is provided. The system comprising at least one processor operably connected to a memory, the at least one processor when executing configured to manage communication with at least a plurality of users and/or user subsystems, wherein the at least one processor is configured to accept a plurality of messages from the user and/or user subsystems according to a respective plurality of communication formats or protocols optionally, match data operations (e.g., orders) within the accepted messages translate the messages and/or matched data operations into a second communication format specified by a controller subsystem for the plurality of messages, associate a respective unique identifier with a respective operation manage by the system communicate the translated messages to the controller subsystem receive execution status information associated with the respective message and data operation from the controller subsystem, and associate the execution status information with the respective unique identifier and respective operation.

According to one embodiment, wherein the at least one processor is configured to monitor a respective system status for the respective operation. and automatically execute management operations based on a time period associated with the respective operation. According to one embodiment, the at least one processor instantiates an abstraction layer, wherein the abstraction layer is accessible via API or user interface, and the abstraction layer is configured perform operations to manage the communication, match the data operations (e.g., orders), translate the messages and/or the matched data operations (e.g., orders), associate the respective unique identifier, communicate the translated messages, receive the execution status, and associate the execution status information with the respective unique identifier. According to one embodiment, the at least one processor is configured to match states to instrument inventory based on execution acknowledgements received from the controller subsystem. According to one embodiment, the at least one processor is configured to define a first communication channel having a first format and associate the first communication channel with a respective user and/or user subsystem. According to one embodiment, the at least one processor is configured to map a plurality of message fields of the first communication channel to a communication protocol associated with the controller subsystem. According to one embodiment, the at least one processor is configured to match states to data operations and data targets (e.g., instrument inventory) managed by the controller subsystem based on execution acknowledgements received from the controller subsystem (e.g., settlement and exchange system).

According to one embodiment, the at least one processor is configured to define a first communication channel having a first format and associate the first communication channel with a respective user and/or user subsystem. According to one embodiment, the at least one processor is configured to map a plurality of message fields of the first communication channel to a communication protocol associated with the controller subsystem. According to one embodiment, the at least one processor is configured to operate in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.

According to one aspect, a computer implemented method for extending data management (e.g., for maintaining inventory of exchangeable instruments) is provided. The method comprising managing, by at least one processor. communication with at least a plurality of users and/or user subsystems, including accepting a plurality of messages from the user and/or user subsystems according to a respective plurality of communication formats or protocols matching, by the at least one processor, data operations (e.g., orders) within the accepted messages translating, by the at least one processor, the messages and/or matched data operations into a second communication format specified by a controller subsystem for the plurality of messages, associating, by the at least one processor, a respective unique identifier with a respective operation manage by the system communicating, by the at least one processor, the translated messages to the controller subsystem receiving, by the at least one processor, execution status information associated with the respective message and data operation from the controller subsystem, and associating, by the at least one processor, the execution status information with the respective unique identifier and respective operation.

According to one embodiment, the method further comprises monitoring a respective system status for the respective operation, and automatically executing management operations based on a time period associated with the respective operation. According to one embodiment, the method further comprises instantiating, by the at least one processor, an abstraction layer, wherein the abstraction layer is accessible via API or user interface, and the abstraction layer is configured perform operations to manage the communication, match the data operations (e.g., orders), translate the messages and/or the matched data operations (e.g., orders), associate the respective unique identifier, communicate the translated messages, receive the execution status, and associate the execution status information with the respective unique identifier. According to one embodiment, the method further comprises matching states to instrument inventory based on execution acknowledgements received from the controller subsystem. According to one embodiment, the method further comprises defining a first communication channel having a first format and associating the first communication channel with a respective user and/or trading subsystem. According to one embodiment, the method further comprises mapping a plurality of message fields of the first communication channel to a communication protocol associated with the settlement and exchange subsystem.

According to one embodiment, the method further comprises matching states to data operations and data targets (e.g., instrument inventory) managed by the data controller subsystem based on execution acknowledgements received from the data controller subsystem (e.g., settlement and exchange system). According to one embodiment, the method further comprises defining a first communication channel having a first format, and associating the first communication channel with a respective user and/or user subsystem. According to one embodiment, the method further comprises mapping a plurality of message fields of the first communication channel to a communication protocol associated with the data controller subsystem. According to one embodiment, the method further comprises operating in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.

According to one aspect, a system for interface control (e.g., data verification for maintaining inventory of instruments) is provided. The system comprising at least one processor operably connected to a memory, the at least one processor when executing configured to manage communication with at least a plurality of users and/or user subsystems (e.g., trading systems), wherein the at least one processor is configured to process a message queue including a plurality of messages from the user and/or user subsystems according to a plurality of communication formats or communication protocols match data requests (e.g., orders) within the accepted messages translate the messages and/or matched data requests (e.g., orders) into a second communication format consistent with a format for a data controller subsystem (e.g., settlement and exchange system) for the plurality of messages, associate a respective unique identifier with a respective operation defined by a respective one of the accepted messages (e.g., including for a first request a first encoded identifier, a second request a second encoded identifier, a third request a third encoded identifier, etc.) communicate the translated messages to the data controller subsystem receive execution status information for the translated messages from the data controller subsystem, and associate the execution status information with the respective unique identifier and respective operation associated with the plurality of messages.

According to one embodiment, the at least one processor is configured to route respective messages to respective user subsystems based on respective unique identifiers. According to one embodiment, the at least one processor is configured to match data operations within the message queue, construct an aggregate data request from matching messages, and wherein the operation to communicate the translated messages is based on a consolidation of the message queue and the aggregate data. According to one embodiment, the at least one processor is configured to enhance communication security based on consolidating matched data in the message queue and communicating the match data as an aggregate request for any matching data operation. According to one embodiment, the at least one processor is configured to monitor a respective system status for the respective operation, and automatically execute management operations based on a time period associated with the respective operation defined by the status communicated with the respective operation.

According to one embodiment, the at least one processor instantiates an abstraction layer, wherein the abstraction layer is accessible via API or user interface, and the abstraction layer is configured perform operations to manage communication, match the data request or data target (e.g., orders), translate the messages and/or the matched data request (e.g., orders), associate the respective unique identifier to respective data requests and/or to aggregations of data requests, communicate the translated messages, receive the execution status, and associate the execution status information with the respective unique identifier. According to one embodiment, the at least one processor is configured to match states to data operations and data targets (e.g., instrument inventory) managed by the data controller subsystem based on execution acknowledgements received from the data controller subsystem (e.g., settlement and exchange system). According to one embodiment, the at least one processor is configured to define a first communication channel having a first format, and associate the first communication channel with a respective user and/or user subsystem.

According to one embodiment, at least one processor is configured to map a plurality of message fields of the first communication channel to a communication protocol associated with the data controller subsystem. According to one embodiment, the at least one processor is configured to operate in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.

According to one aspect, a computer implemented method for interface control (e.g., data verification for maintaining inventory of instruments) is provided. The method comprising managing, by at least one processor, communication with at least a plurality of users and/or user subsystems (e.g., trading systems), wherein the at least one processor is configured to process a message queue including a plurality of messages from the user and/or user subsystems according to a plurality of communication formats or communication protocols matching, by the at least one processor, data requests (e.g., orders) within the accepted messages translating, by the at least one processor, the messages and/or matched data requests (e.g., orders) into a second communication format consistent with a format for a data controller subsystem (e.g., settlement and exchange system) for the plurality of messages, associating, by the at least one processor, a respective unique identifier with a respective operation defined by a respective one of the accepted messages (e.g., including for a first request a first encoded identifier, a second request a second encoded identifier, a third request a third encoded identifier, etc.) communicating, by the at least one processor, the translated messages to the data controller subsystem receiving, by the at least one processor, execution status information for the translated messages from the data controller subsystem, and associating, by the at least one processor, the execution status information with the respective unique identifier and respective operation associated with the plurality of messages.

According to one embodiment, the method further comprises routing respective messages to respective user subsystems based on respective unique identifiers. According to one embodiment, the method further comprises matching data operations within the message queue, constructing an aggregate data request from matching messages, and wherein the operation to communicate the translated messages is based on a consolidation of the message queue and the aggregate data. According to one embodiment, the method, further comprises enhancing communication security based on consolidating matched data in the message queue and communicating the match data as an aggregate request for any matching data operation. According to one embodiment, the method further comprises monitoring a respective system status for the respective operation, and automatically executing management operations based on a time period associated with the respective operation defined by the status communicated with the respective operation. According to one embodiment, the method further comprises instantiating an abstraction layer, wherein the abstraction layer is accessible via API or user interface, and the abstraction layer is configured perform operations to manage communication, match the data request or data target (e.g., orders), translate the messages and/or the matched data request (e.g., orders), associate the respective unique identifier to respective data requests and/or to aggregations of data requests, communicate the translated messages, receive the execution status, and associate the execution status information with the respective unique identifier.

According to one embodiment, the method further comprises matching states to data operations and data targets (e.g., instrument inventory) managed by the data controller subsystem based on execution acknowledgements received from the data controller subsystem (e.g., settlement and exchange system). According to one embodiment, further comprises defining a first communication channel having a first format and associating the first communication channel with a respective user and/or user subsystem. According to one embodiment, the method further comprises mapping a plurality of message fields of the first communication channel to a communication protocol associated with the data controller subsystem. According to one embodiment, the method further comprises operating in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.

Other advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example implementation, according to one embodiment;

FIG. 2 is a block diagram and process flow, according to one embodiment;

FIG. 3 is a conceptual view of operations made transparent to end users, according to one embodiment;

FIG. 4 is a conceptual view of operations made transparent to end users, according to one embodiment;

FIG. 5 is a block diagram and process flow, according to one embodiment;

FIG. 6 is an example of processing time windows, according to one embodiment;

FIG. 7. is a block diagram of a system that is improved based on execution of the functions, operations, and/or processes disclosed herein;

FIG. 8 is an example process flow, according to one embodiment;

FIG. 9 is an example process flow, according to one embodiment;

FIG. 10 is an example process flow, according to one embodiment;

FIG. 11 is an example process flow, according to one embodiment;

FIG. 12 is an example process flow, according to one embodiment;

FIG. 13 is an example process flow, according to one embodiment; and

FIG. 14 is an example process flow, according to one embodiment.

### DETAILED DESCRIPTION

According to various embodiments, a management, aggregation, and reconciliation system is configured to manage interactions between end users (e.g., associated systems) and services provided by the DTCC or similar CCP and CSD combination(s). In some embodiments, the management, aggregation, and reconciliation system operates as an intermediary system that is configured to extend the functionality and operations defined by any CCP (including, for example, one operated by the NSCC). For example, the intermediary system manages communication from the end users and the DTCC interacting with the system via a user interface into the system. In other examples, the system provides APIs to enable native operations on end user or client systems, translation to compliant messaging (e.g., specified by any clearing system (including the DTCC), tracking of the results of execution, and returning communications to the end user or client systems. In further embodiments, the system provides an enhanced data model and function set over the services provided by the conventional clearing system (e.g., DTCC). For example, DTCC operation, functions, and supporting data model provides day-to-day or overnight lending services. This DTCC implementation under execution can ignore prior day activity and reconciles only within the DTCC defined time frame (intra-day). According to various embodiments, by enhancing the architecture and/or data model as provided by the system, time-based tracking of daily expiring data can be managed seamlessly and transparently to users or systems leveraging clearing services, including those provided by the DTCC.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

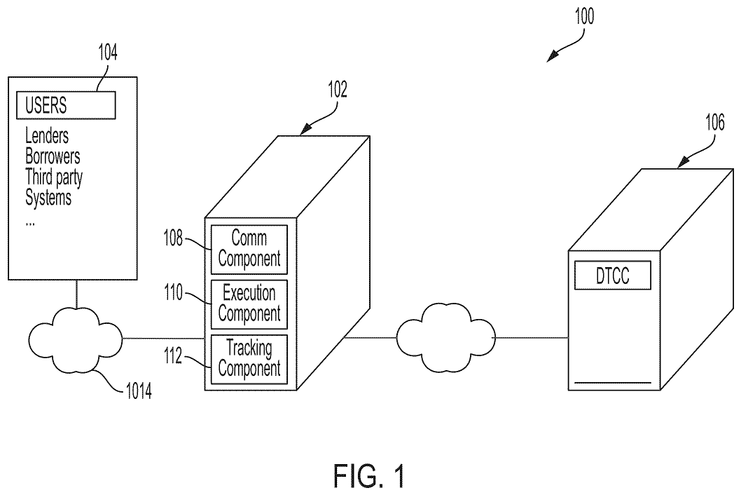

FIG. 1 is a block diagram of an example architecture 100. As shown in FIG. 1 an intermediary system 102 can be configured to manage interactions between security lenders, borrowers (e.g. users 104) and the DTCC clearing systems (e.g. 106), shown as an example of a central clearing system that is representative of conventional approaches, and technological short falls of conventional architectures. The intermediary system 102 can also be configured to manage the interaction between provider systems, their respective clients and any clearing system (including, for example, the DTCC). In some embodiments the intermediary system operates as an abstraction layer that is configured to manage communication protocols of the respective participants, extend the functionality of any clearing system provided (e.g., by the DTCC), and manage enhanced data models to facilitate such functions.

According to one embodiment, the system 102 can include a communication component 108. The communication component 108 can be configured to manage a plurality of communication protocols on behalf of respective users and/or systems. According to one example, the communication component 108 can be configured to manage a communication protocol based on the FIX specification, among other options. In further examples, the communication component 108 can be configured to manage a plurality of communication protocols that are based on the FIX specification. In some embodiments, specific providers, lenders, borrowers, and/or third-party systems (e.g., users 104) can each be linked to a specific communication protocol, and the communication component can select a formatting for messages to the respective recipient.

In some embodiments, the communication component 108 can be configured to translate the communication received from any user into a communication formatted for execution at any clearing system. For example, various fields within a communication message can be mapped into a message for execution at the DTCC. In further embodiments, the communication component can be configured to process or communicate via other protocols including, for example, MQ or via web socket.

According to some examples, the system 102 can include an execution component 110. The execution component 110 is configured to execute order matching on received requests from the users 104. In some examples, users may wish to lend securities while other users may wish to borrow, and the execution component 110 can be configured to perform order matching operations on any received requests. The matched orders can be communicated for clearing and settlement operations. Importantly, the system and various components are configured to manage the results returned from any clearing system (e.g., the DTCC) and specifically link the communications provided to specific identifiers that can be used to track lending operations and facilitate functionality over time frames that conventional systems do not recognize.

According to one embodiment, the tracking component 112 can be configured to generate and manage unique identifiers for any such user request (e.g., lend, borrow, recall, rebate, return, accept, etc.) and link the communications received to those unique identifiers. According to some embodiments, the extended data format and data model provided by the system enables a temporal connection to the respective lend operation over time, whereas the data provided to and returned from conventional implementation is lacking in this information and fails to provide such functionality.

According to some embodiments, the tracking and execution components operate together to manage loan functions that have extended time frames beyond conventional approaches. In one example, the system can manage in operation having a settled status (e.g., acknowledged by the DTCC) and a duration greater than that tracked by the settlement operations. For example, the system can assign an open state where the state corresponds to a time variable for which the loan should remain open. The system is configured to automatically re-generate the loan data at any associated clearing system (e.g., the DTCC) for those having an open status or state. In one example, the system automatically generates and communicates a roll operation for an open and pending loan to maintain the pending status of the securities loan within the DTCC system.

For the users and/or client systems this means that the users and/or client systems do not need to continuously interact with respective clearing systems to maintain an open lend regardless of the time window and, for example, the requirements typically imposed by the DTCC. The system can also be configured to manage a life cycle of lend, borrow, or other operations directly with any clearing system (e.g., the DTCC (described in greater detail below)), and link the communication and/or execution of those management operations to a unique system identifier that tracks those operations over time. The ultimate status and results of the life cycle management can be provided to any users and/or user systems to enable the same. In further examples, the system can provide access to and/or maintain an operation log associated with the respective identifiers. In some embodiments, system operation is based on queuing and executing messages in queue. In some examples, the queue based implementation is configured to preserve the ordering of operations.

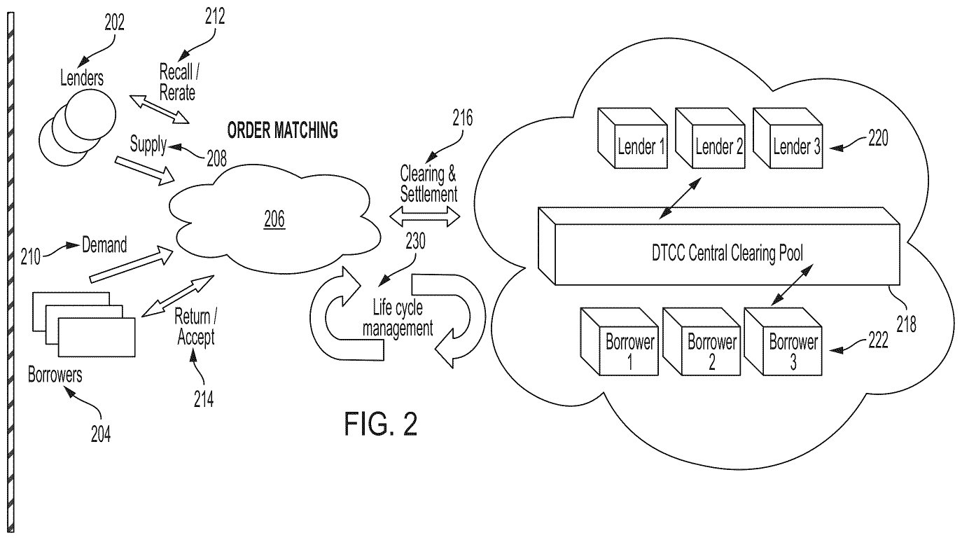

Shown in FIG. 2 is a block diagram and process flow for managing securities financing transaction (“SFT”) operations with the DTCC to provide an example of operations that can be used generically with respect to any clearing system. As shown, lenders 202 and borrowers 204 can issue requests on the system 206. The requests can include basic functionality including supply at 208 and demand at 210. The supply and demand operations correspond to lending and borrowing of securities instruments. The system can also accept update operations that include recall/re-rate at 212 and return/accept at 214. The return/accept operation allows a borrowed security to be returned to a lender and the recall/re-rate allows a lender to request return of their instrument or a change in terms to the lend of the instrument. The system 206 can be configured to match any requests submitted and translate the requests from any client communication format into a format compatible with DTCC execution. According to one embodiment, the matched requests are formatted and communicated to the DTCC for clearing and settlement operations at 216. The DTCC includes a clearing pool 218 that records the respective lens and borrows that have been submitted and settled. For example, the data records in the clearing pool can include any number of lenders (e.g., 220) and respective instruments as well as any number of respective borrowers (e.g., 222) and associated instruments.

As discussed above, the DTCC clearing pool stores and maintains records on a day-to-day basis. Thus, any loan or borrow activity that extends beyond a single day must be renewed each day with the DTCC. The DTCC systems treat each such request as a new origination and assign new identifiers to the settlement activity that is requested. In various embodiments, the intermediary system 206 is configured to manage the new identifiers and link them to the unique system identifier assigned. By tracking all activity executed at the DTCC with respective unique identifiers, the intermediary system 206 is able to manage the life cycle of all activity requested beyond the time frames permitted by the DTCC.

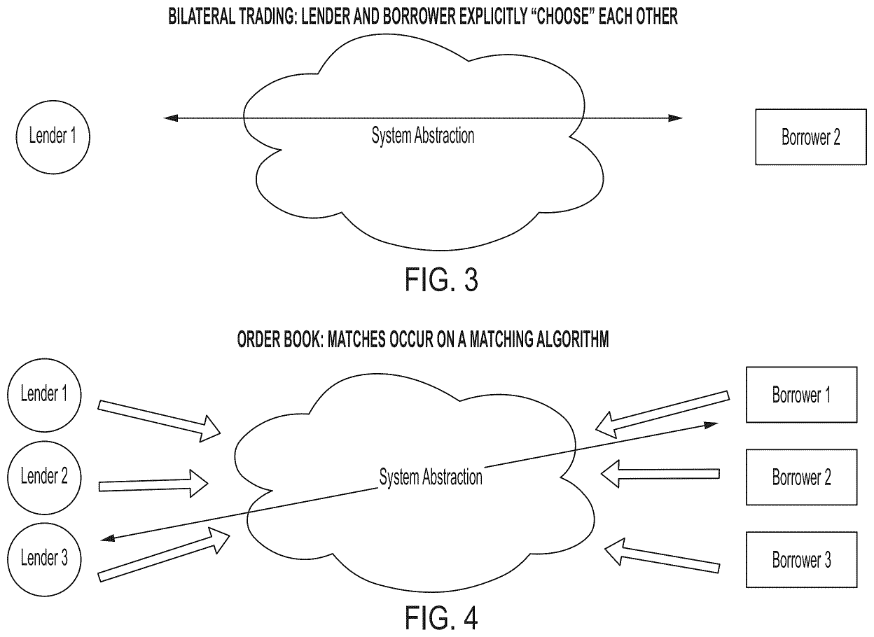

Shown in FIG. 3 is a conceptual process flow where a lender and borrower can explicitly choose to interact, for example, via the intermediary system. Under historical approaches, any lender and any borrower would be able to interact directly and effect a desired exchange. Under conventional central clearing architectures, the same exchange cannot take place. For example, using the central clearing architecture provided by the DTCC, a first lender would in fact lend their securities to the DTCC and have their lend acknowledged. The borrower would ask to borrow the security from the central clearinghouse, and the central clearinghouse would lend the security (e.g., of the requested kind), not necessarily from the desired lender. Various embodiments resolve the additional complexity of any central clearing house architecture and enable a lender to exchange directly with a borrower and make the operations and interactions with any central clearing system that are required transparent to the participants.

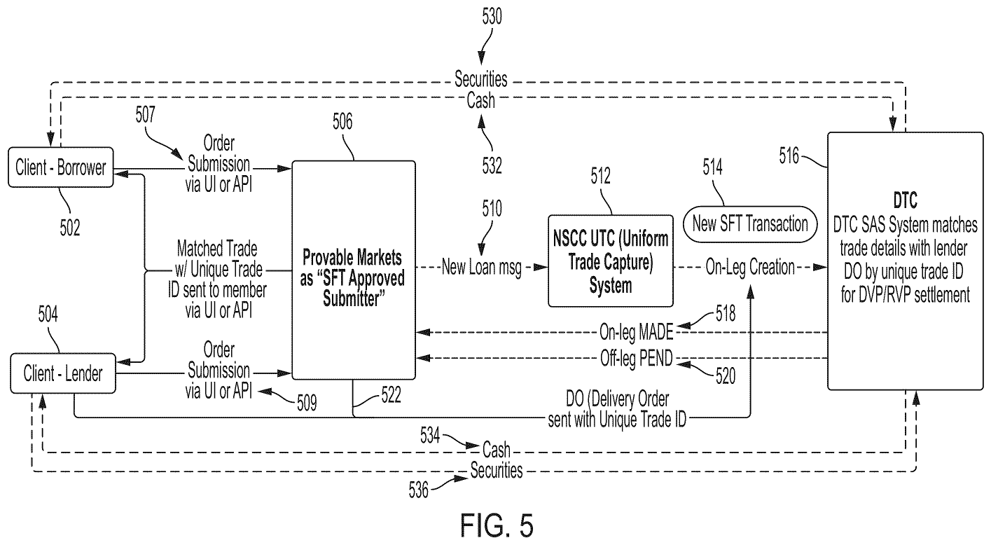

Shown in FIG. 4 is a conceptual process flow where multiple lenders and multiple borrowers can provide their desired quantity for lending and borrowing and have matches resolved prior to invoking the clearing house operations (e.g., of the DTCC). In various embodiments, the system is configured to accept requests from a plurality of users and perform order matching on the securities lending requests. Once the matching has been resolved, the system is configured to communicate the matched orders as well as any unmatched activity. In some examples, this enables the system to reduce the required communications to the DTCC systems by consolidating and only communicating aggregate or matched information, thereby improving the efficiency of the system overall. Similarly clearing operations performed by the DTCC can be reduced because of the matching that occurs in advance of invoking the clearinghouse. In still other examples, acknowledgments generated by the DTCC are likewise streamlined and reduced relative to operations that do not use an intermediary system.

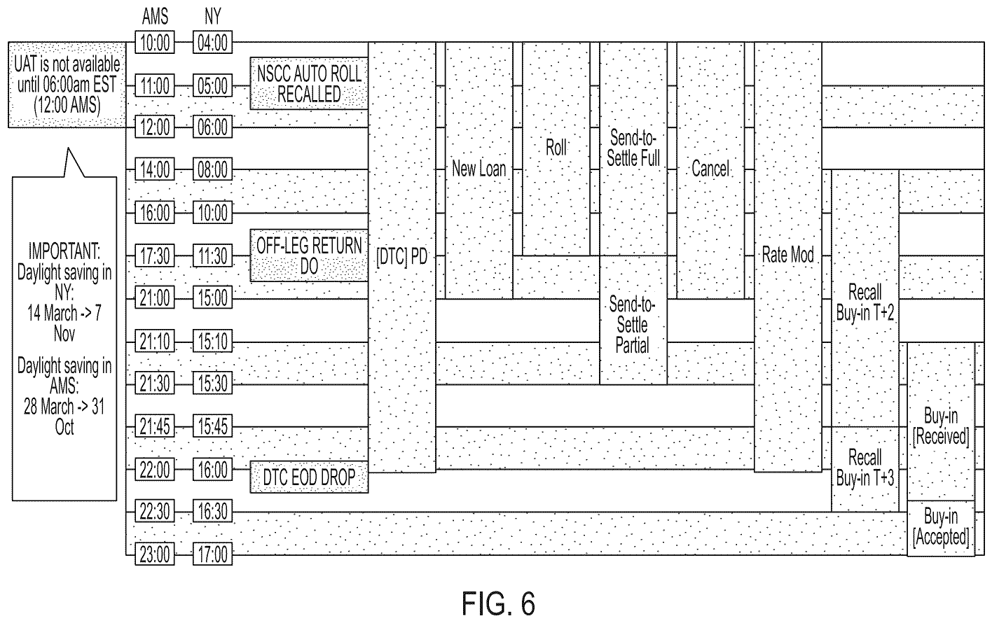

FIG. 5 shows a block diagram and process flow of an example implementation of a current clearinghouse and processing environment. FIG. 5 illustrates example functions, operations, and communications performed with respect to the DTCC system that can be used more generically with respect to any clearing house system. As shown, client borrowers and client lenders (e.g., 502-504) can use the system 506 to provide for order submission. Order submission (e.g., 507, 509) can occur via the user interface directly to the system 506 or via an API call. Based on the functions requested by the client borrower or client lender, the system 506 is configured to, for example, generate new loans by creating a new loan message and communicating the message to a first processing system 512. The first processing system, assuming a valid request, communicates a creation message at 514 to a second processing system 516. At a high level the first and second processing systems can be envisioned as the clearinghouse for lending and/or SFT transactions. In this example, the two systems are shown separately to highlight the participating systems and respective entities responsible for them. For example, the first processing system 512 is operated by the National securities clearing Corporation (NSCC), which communicates directly with the Depository Trust Company (DTC) each subsidiary entities of the DTCC having their own, but co-operative, systems, and together they collectively provide the services and functions to enable a clearinghouse for SFT transactions. Collectively, the first and second processing systems can be referred to as the DTCC.

If the creation message is valid the second processing system 516 reports back to the system 506 that the request has been made at 518, or that the request is pending. From the clients' perspective, the client lender 504 submits a delivery order set with the unique trade ID that is handled by the system 506 communicated as part of the reconciliation between the first and second processing systems it results in in acknowledgment and tracking of the loan information on the system, for example using the unique trade ID. At a higher level the dashed lines (530-536) illustrate the exchange of securities and the payment or receipt of costs for engaging in the FST transaction.

According to various embodiments, the clients interface with the system 506 for SFT creation, maintenance, and life cycle management operations (discussed in greater detail below). The management operations and/or life cycle management operations become transparent to the clients of the system, and the complexities of the creation, life cycle management, and maintenance are handled entirely by the system 506. The system can be configured with user interface access for clients and/or to include APIs for accessing the functionality of the system. The system can provide for SFT initiation, monitoring, and automatic life cycle management, among other options. For example, automatic functions include system messaging to the first and second processing systems, tracking and reconciling responses received, and linking the information received from the processing systems to unique system identifiers that enable tracking and management of the entire life cycle of the SFT transaction.

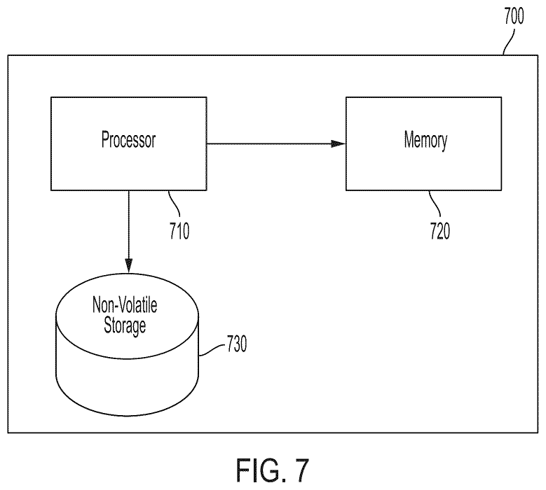

As part of managing the functions and operations accessible via the clearinghouse systems (e.g., processing systems 512 and 516), the system is configured to perform operations according to the timetables required by the clearinghouse. FIG. 6 illustrates various time windows for a processing day impose by the DTCC architecture, and the operations that the system is configured to initiate with the processing systems to effect SFT transactions and respective timing.

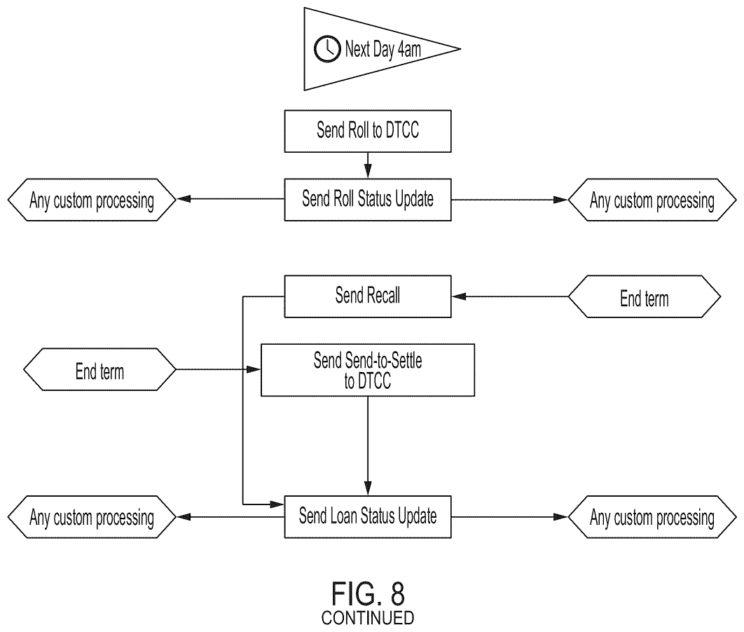

According to various embodiments, the operations between the various system elements can be processed based on messaging and queuing such messages. The life cycle management flows below can likewise be used as part processing queued messages and triggering status updates as each message is processed through respective queues. In various embodiments, the processing systems (e.g., the DTCC) is the ultimate source of authority on status of any given request and/or exchange. Thus, the queued execution can be configured to immediately report errors back to requesting parties. In various examples, the system by design limits corrective activity, so that the responsibility of taking action in response to errors is handled by the most interested party (e.g., the requestor), and there is little or no possibility of the system to introduce interpretive errors (and consequently little opportunity to impact the ultimate source of authority). FIG. 8 is an example process flow that shows example interactions between a borrow client and lend client managed by the system.

### Life Cycle Management Examples

The following examples include automatic management and life cycle management functions performed by various embodiments of the system. The examples are described to illustrate functionality the system provides to extend conventional architectures and conventional operations into new functions, visualizations, and/or to provide transparent execution to clients and/or client systems. In the following examples, the diagram blocks define status update messages that the system can send over “real-time” integrations such as FIX, MQ or websocket, among other options. The circles described are the subsequent system state after a status update and can be reported as reflecting the current status, for example, when queried (e.g., using REST or gRPC APIs, among other options). In the examples, the arrow-like shapes in the diagram define triggers/actions that are executed or received from the system or executed or received from one of the counterparties (e.g., processing systems, DTCC, etc.). Status update messages are configured to contain one or more or any combination of the following fields of the transaction (e.g., loan), and likewise requests via REST or gRPC APIs:
Status
CUSIP
Counterparty
[Current] Rate
Original Quantity
Total Returned Quantity
Total Recalled Quantity
Total Quantity which can be Bought-in
Total Bought-in Quantity
Remainder/Open Quantity
Unless otherwise specified parties receive the same messages, though some fields will vary depending on their side of a given trade.

### Example Creation and (Onleg) Settlement (e.g., Open Loan)

According to one embodiment, life cycle (e.g., management) starts as soon as parties have agreed to establish a loan, this can be from a borrower using the marketplace, or two parties agreeing to book a “manual loan.” (e.g., a direct exchange between explicit parties). After receiving the Pending Settlement message, the lender locks up the shares to prevent lending out the same shares elsewhere and then a Delivery Order (“DO”) is communicated with the DTCC Reference ID attached. The system can manage this operation automatically for integrated users, and in further embodiments, for lenders who are less tightly integrated, the system notifies the user's trading desk (e.g., through desktop and email notifications) request that they lock up the shares and communicate the DO once complete. At this stage, the loan is in the pending settlement state-it is possible that DTCC may reject the loan and when that happens a Reject/Fail message will be sent, moving the loan into the Rejected state, which is an end of the flow.

According to some examples, while the loan is in the Pending Settlement state it is possible for either or both parties to attempt to cancel the loan, either with the web UI or through a Cancel message (e.g., via API). The system is configured to receive a cancel request and on an urgent basis notify the DTCC to cancel the settlement—if successful, the system updates status and notify both parties with a Canceled status update. Edge cases include the events where roughly at the same time as the Cancel message is received the DO is also made, in which case we might be too late to notify DTCC to cancel the settlement, in that case a Settled status update will be observed and that implies the system failed to cancel in time. In another example, if the DO is not made before the End of Day settlement cutoff (“EOD Drop”) then a Dropped status update will be sent, similar to Rejected and Canceled this is a flow end. When a DO is communicated and processed in time, then a Settled status update is produced, moving the loan into the Open state. The example flow is illustrated below.

### Open State Examples

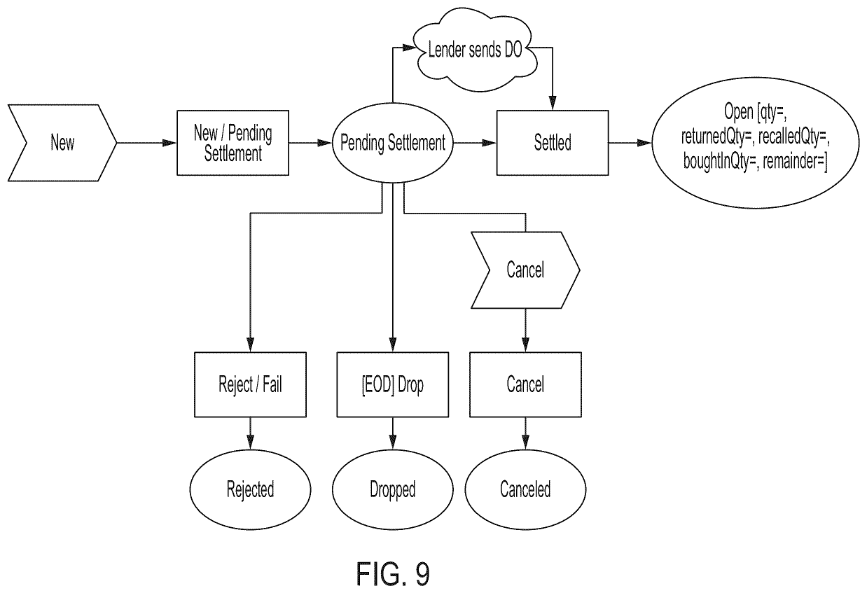

According to one embodiment, as shown in the flow of FIG. 9, once the loan has settled and has been confirmed in the Open state, the system is configured to automatically roll (e.g., regenerate) the operation every morning, and trigger the clearing/controller system to create a new reconciliation daily. The system is configured to handle these operations automatically on behalf of the user. In various examples, execution of these operations triggers a result of a

Rolled status update on the intermediary system, though in some edge-cases this status update is not produced, however unless a Returned, Terminated or Buy-in Execution message is observed the loan is configured to remain open regardless. In further embodiments, any actions done throughout the day to modify the rate field of the loan is giving a pending status until the EOD period is reached (e.g., shown in FIG. 6, at which point the system is configured to generate a single Rate Mod status update (e.g., if the rate actually changed) with the rate used for the actual rate calculation).

According to some embodiments, responsive to a return request from a borrower for (e.g., the whole or a part of) the shares, the system is configured to generate and communicate a Return status update. The update specifies how many shares are returned and as with the various status updates contains the total amount of returned, recalled, and bought-in shares and the remainder of open shares. The system is further configured to process shares on recall when a return request is received by decrementing the total amount of shares being recalled. Once the remainder has reached 0 (either from being returned or from a buy-in execution) the loan will be considered Closed and its status updated. Similarly, responsive to a return request (e.g., recall or rerate) by a lender (for all or part of their shares), the system is configured to produce a status update that specifies how many shares are being recalled and will contain the total amount of returned, recalled, and bought-in shares and the remainder of open shares. In further embodiments, when a buy-in window has been reached a lender can initiate a buy-in execution, the system notifies the respective parties, and again the totals will be updated.

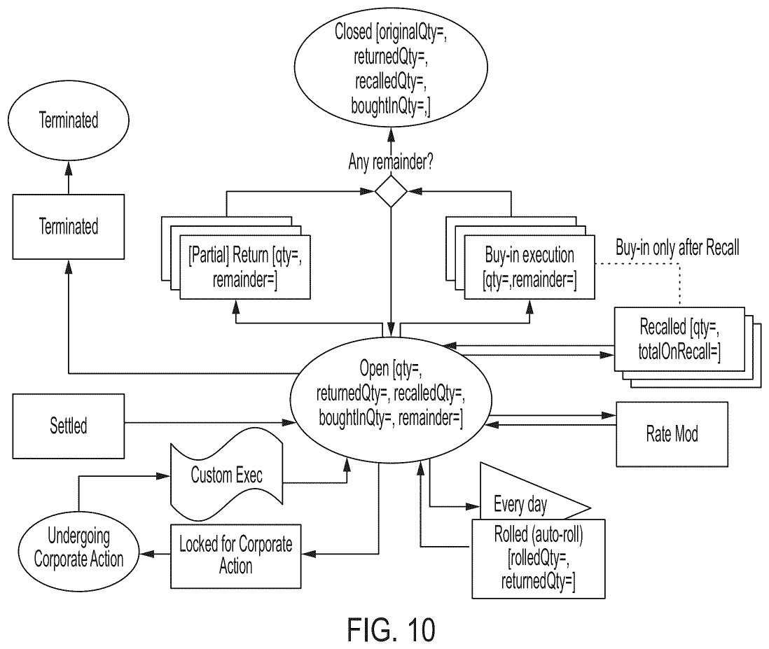

Also shown is the potential for abnormal paths in the flow in FIG. 10, where 1) a loan can be Terminated (e.g., either by NSCC or by the system) in some special cases, in which case the loan life cycle ends immediately, without the shares being returned; and 2) a loan can undergo a corporate action, which can be process by the system according to customized actions for respective corporate action (e.g., merger, bankruptcy, etc.)

### Return Request Example

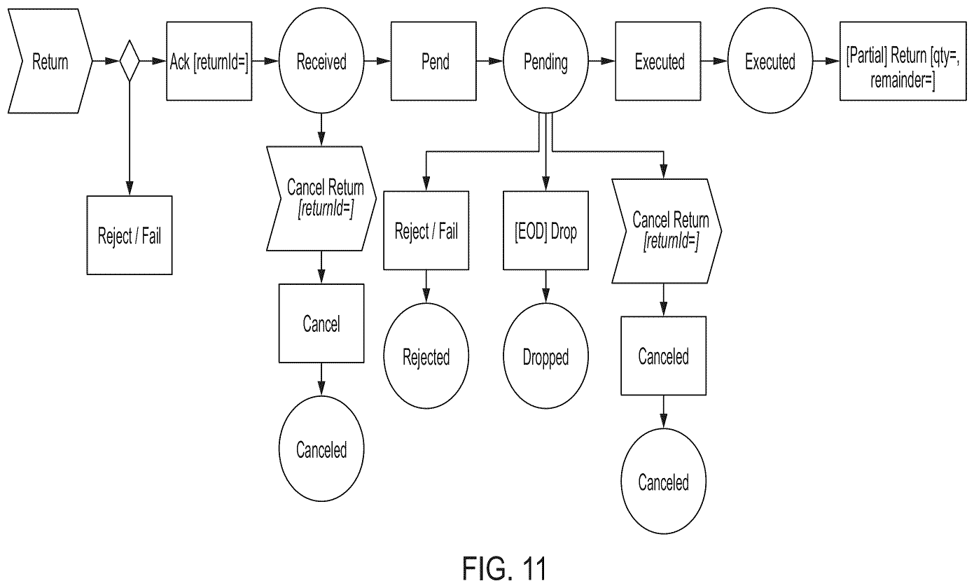

According to one embodiment, the flow shown in FIG. 11 enables the system to process return request. For example, when a borrower wants to return their borrowed shares (or any part) the user can initiate a Return Request via the system or API. For example, the system can be configured to generate (or require the borrower to provide) a unique identifier with the request, and the system links this identifier to the subsequent actions (and throughout any life cycle). In some examples, the return request can be rejected (instantly) by the system if there is something wrong (e.g., the request is invalid, cannot be verified, etc.) in which case the first (and last) message related to the return request is a Reject/Fail message.

As shown below, if the request is not instantly rejected, the system produces an Ack message and initiates the return process by communication to the DTCC. A pend message is produced by the system in response to a DTCC acknowledgement. During both of these states it is possible for a user (e.g., the borrower) to initiate a Cancel Return, which operates in a similar fashion to Cancel for the settlement of a loan. The system can increase the priority of such operations to enable fast resolution of the notification to the DTCC systems of the cancellation, increasing the ability to successfully produce a Canceled message.

If the cancel is not processed, then an Executed message will be received from the DTCC, and this implies the cancel failed. While the return is pending with DTCC it is still possible for DTCC to reject the return, which would produce a Reject/Fail message to the system. If DTCC is unable to execute the return and the EOD drop time is reached, then a Dropped message is produced. This example should only occur if the shares are not available to be returned. If the request was processed correctly, an Executed message is produced for the Return Request, and then a Return loan status update is produced (for both parties (e.g., lender/borrower) to indicate the updated status of the loan.

### Recall Request Example

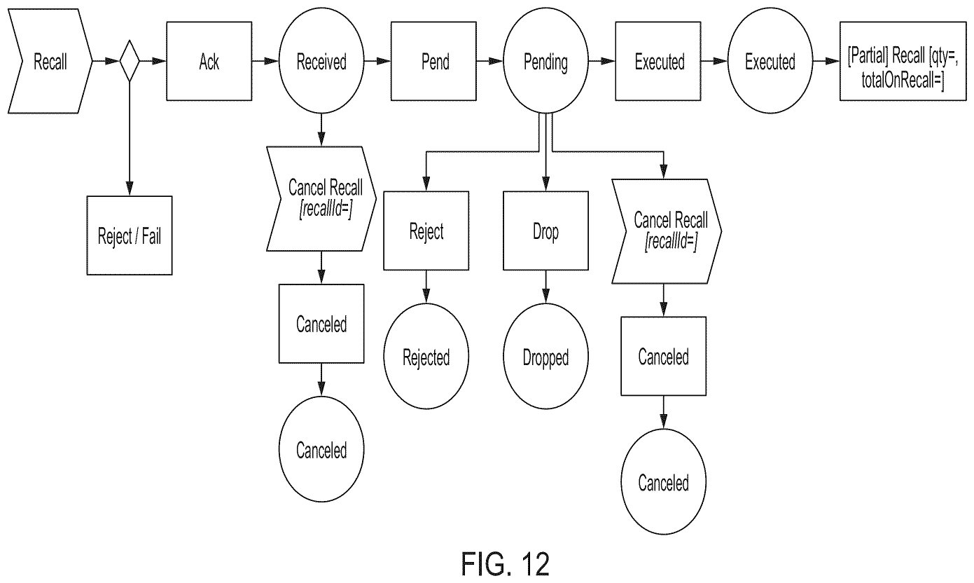

In various embodiments, execution of a recall proceeds similarly to the Return Request described above. Shown in FIG. 12 is a process flow for processing a recall request. In other embodiments, buy-in operations can be executed in a similar manner. As shown, depending on the time when a recall request is issued (e.g., sent by a user), the system is configured to execute the operation at specific time windows (e.g., T+2 or T+3 shown in FIG. 6).

The basic operation examples above provide for creation and return, and may be used, for example, in conjunction with direct lend/borrow request. The system is configured to provide a marketplace for declaring and matching desired volumes of lend and borrow activity. The desired quantities can match by the system and the life cycles for the underlying activity automatically managed by the system. The following process flow can be executed to facilitate operation.

According to some embodiments, the system can be configured to generate and/or request a unique identifier that the system can use to track the status of a given request. In some examples, a unique ID of the uuid4 format can be used. In other examples, any random or sequential ID can be used. In still others, the system can associate a client provided ID to a system generated one, and map between the two identifiers through the transaction life cycle.

### Example Lend Position Create Request

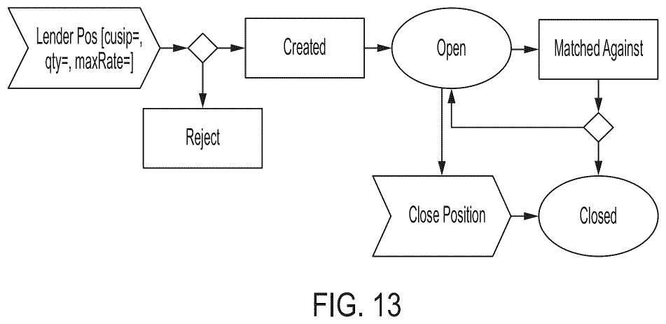

As shown in FIG. 13, a process flow can be executed by the system to enable a lender to create a position for matching. The system can be configured to allow for an end date on any position, allow slower systems to, for example, define liquidity values (e.g., in the morning) and enable the system to flush everything at the end of the day, and loop for the next time period. According to various embodiments, the system enables partial matching, which may be controlled based on client inputs (e.g., allow/disallow partial match/fill). A close position request can be submitted to the system to close the position. The close position can be either rejected with a Reject or result in a Closed message.

### Example Borrow Request

As shown in FIG. 13, the process flow can be executed by the system to enable a borrower to create a position for matching. In some embodiments, the system enables the borrower to specify a maxRate or a range, and the system will execute matches to define the best available rate that stays within that specified constraint. In other examples, the borrower can specify on the system a specific counterparty to borrow from, in which case the system is configured to ignore other lender positions. By default, a lender is not specified, and the system takes from the positions with the best rates. During execution, the request receives a Reject or proceeds to Matched/No Match. In some examples, no Ack is required in between, and by default execution occurs on a Fill-or-Kill, and All-or-None basis. The return of matched results in an update status of Matched Against for the lender position, and for example, can be configured to start the new step of a new loan (above). In various embodiments, the system is configured to include and/or associate a reference to a unique request identifier with the loan status updates.

### Example Message and State Diagram

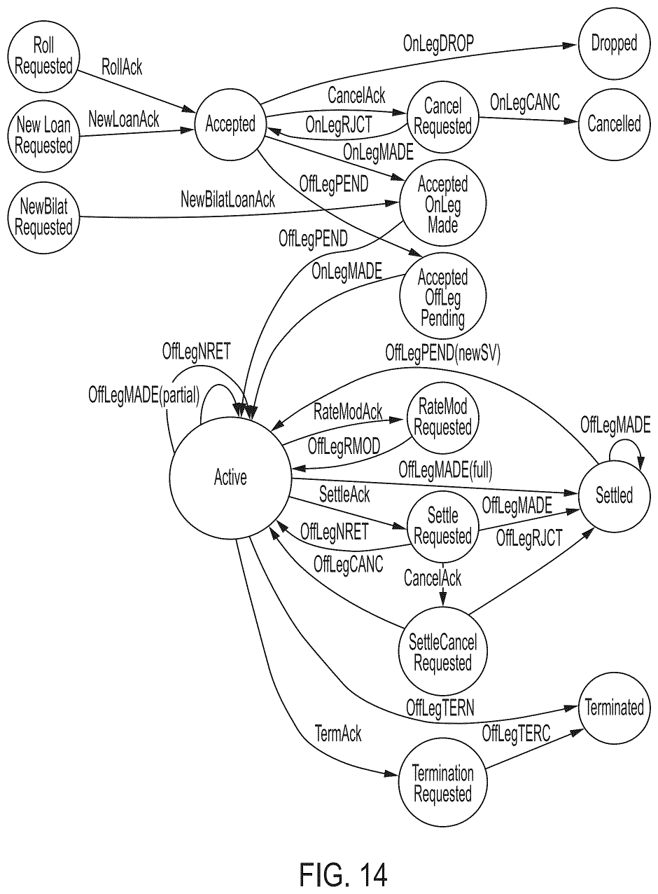

Shown in FIG. 14 is an example message and state diagram implemented in various embodiments that provides additional detail on the example life cycle management operations discussed above.

### Example System Interactions

According to various embodiments, the intermediary system can be configured as a bridge between primary system (e.g., trading platform or trading system) or user systems (e.g., trading systems or platforms) and a controller and/or clearing system. According to various embodiments, the intermediary system can be configured to provide an abstraction layer in the existing architecture that enables primary or user systems to interact with the abstraction layer having enhanced functionality over a limited function controller/clearing system.

In some embodiments, the abstraction layer enables improvements and functionality, and improvements in security, as well as improving the execution efficiency of the entire architecture over various conventional implementation. According to one example, the abstraction layer is implemented via application programming interfaces (APIs) that manage communication between a primary or user system and the intermediary system. In some examples, the primary or user systems provide a host of native operations that users can access and interact with user interfaces designed specifically for the primary system. Native identifiers for users can be stored on the primary system. According to one embodiment, the security of user identification (e.g. native identifiers) can be assured and improved by implementing anonymized identifiers that are used to interact with the abstraction layer (e.g. or more specifically the API to the intermediary system).

In other embodiments, the intermediary system and interaction with a primary system can be governed in a pass-through mode of operation as well as the above enhanced security method of operation. For example, in a pass-through setting the primary system can pass along native operations in a native identifier via an API to the intermediary system, and this approach can improve the efficiency and execution of native operations of the primary system that invoke functionality on the controller or clearing system. By linking the user identifier in the API communications that can be triggered directly by a user operating on the primary system, the intermediary system can more efficiently process the respective operation and more effectively manage the agnostic operations executed by the clearing or controlling system.

In still other embodiments, and users may actually access the intermediary system to improve its interoperability between multiple primary systems. In some examples, users may interact with multiple primary systems and each primary may maintain its own security profile, its own hardware, and prevents access from other primary systems. Even in this context the intermediary system has the capability of enhancing functionality and data management. Because in some examples, the intermediary system operates as an abstraction layer for multiple primary systems the intermediary system can provide an anonymized user identifier to multiple primary systems and while the intermediary system may be able to associate the anonymized user identifier across platforms/primary systems, the anonymized identifier may not permit actual identification of the end user. In various embodiments, this can increase the security profile of the entire system while at the same time allowing access to disparate data sources that were previously incapable of being combined.

In still other embodiments, the ability to leverage data across multiple primary systems provides new functionality even with the agnostic operations performed by the controller/clearing system. Various operations performed via various primary platform systems can now be linked even without understanding the actual identity of a specific user in question. This functionality can even be better leveraged across aggregations of users and operations requested at the controller/clearing system. Multiple primaries can now understand the effect of their operations even across other primary systems to which they normally have no access. This enhanced functionality is simply unavailable in conventional system. In conventional approaches, users and would have to access multiple primary system in order to understand their aggregate data, primary system administrators would ultimately be prevented from understanding aggregate data to which they have no access. Thus, the integration of the intermediary system and functionality improves conventional architecture and functionality.

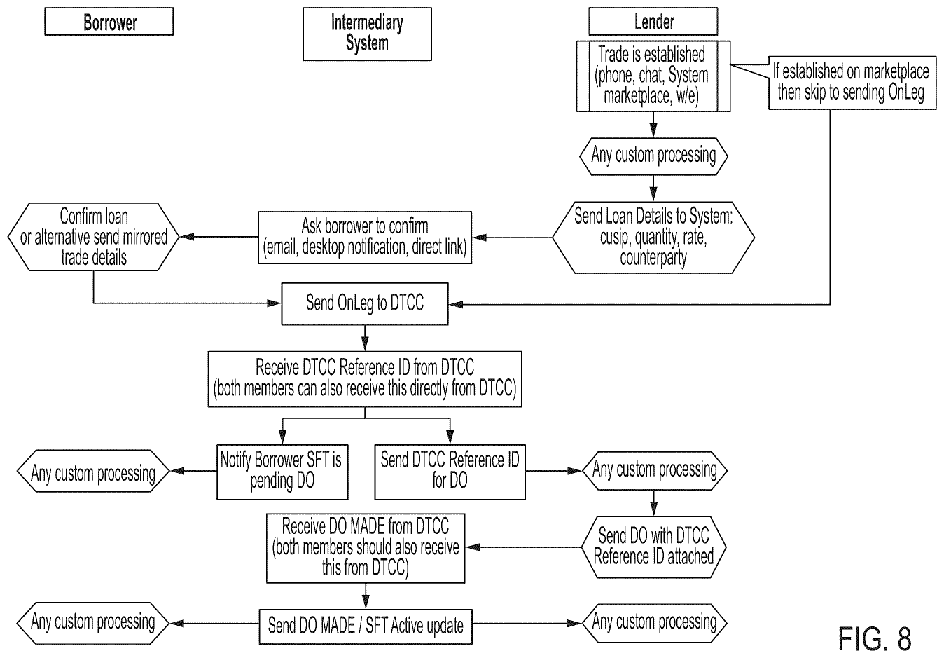

Modifications and variations of the discussed embodiments will be apparent to those of ordinary skill in the art and all such modifications and variations are included within the scope of the appended claims. An illustrative implementation of a computer system 700 that may be improved by execution of processes, functions, architecture, etc., discussed in connection with any of the embodiments of the disclosure provided herein is shown in FIG. 7. The computer system 700 may include one or more processors 710 and one or more articles of manufacture that comprise non-transitory computer-readable storage media (e.g., memory 720 and one or more non-volatile storage media 730). The processor 710 may control writing data to and reading data from the memory 720 and the non-volatile storage device 730 in any suitable manner. To perform any of the functionality described herein, the processor 710 may execute one or more processor-executable instructions stored in one or more non-transitory computer-readable storage media (e.g., the memory 720), which may serve as non-transitory computer-readable storage media storing processor-executable instructions for execution by the processor 710.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to FIGS. 1 and 2A-2B) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A system for extending data management, the system comprising at least one processor operably connected to a memory, the at least one processor when executing configured to:
manage communication with at least a plurality user subsystems, wherein the at least one processor is configured to accept a plurality of messages from user subsystems according to a respective one of a plurality of communication formats or protocols;
optionally, match data operations within the accepted messages;
translate the messages and/or matched data operations into a second communication format specified by a controller subsystem;
for the plurality of messages, associate a respective unique identifier with a respective operation manage by the system;
communicate the translated messages to the controller subsystem;
receive execution status information associated with the respective message and data operation from the controller subsystem; and
associate the execution status information with the respective unique identifier and respective operation.

2. The system of claim 1, wherein the at least one processor is configured to:
monitor a respective system status for the respective data operation; and
automatically execute management operations based on a time period associated with the respective data operation.

3. The system of claim 1, wherein the at least one processor instantiates an abstraction layer, wherein the abstraction layer is accessible via API or user interface, and the abstraction layer is configured perform operations to manage the communication, match the data operations, translate the messages and/or the match data operations, associate the respective unique identifier, communicate the translated messages, receive the execution status, and associate the execution status information with the respective unique identifier.

4. The system of claim 1, wherein the at least one processor is configured to match states to instrument inventory based on execution acknowledgements received from the controller.

5. The system of claim 4, wherein the at least one processor is configured to define a first communication channel having a first format; and associate the first communication channel with a respective user subsystem.

6. The system of claim 5, wherein the at least one processor is configured to map a plurality of message fields of the first communication channel to a communication protocol associated with the controller subsystem.

7. The system of claim 1, wherein the at least one processor is configured to match states to data operations and data targets managed by the data controller subsystem based on execution acknowledgements received from the data controller subsystem.

8. The system of claim 7, wherein the at least one processor is configured to define a first communication channel having a first format; and associate the first communication channel with a respective user and/or user subsystem.

9. The system of claim 8, wherein the at least one processor is configured to map a plurality of message fields of the first communication channel to a communication protocol associated with the data controller subsystem.

10. The system of claim 1, wherein the at least one processor is configured to operate in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.

11. A computer implemented method for extending data management, the method comprising:
managing, by at least one processor. communication with at least a plurality of users and/or user subsystems, including accepting a plurality of messages from the user and/or user subsystems according to a respective plurality of communication formats or protocols;
matching, by the at least one processor, data operations within the accepted messages;
translating, by the at least one processor, the messages and/or matched data operations into a second communication format specified by a controller subsystem;
for the plurality of messages, associating, by the at least one processor, a respective unique identifier with a respective operation manage by the system;
communicating, by the at least one processor, the translated messages to the controller subsystem;
receiving, by the at least one processor, execution status information associated with the respective message and data operation from the controller subsystem; and
associating, by the at least one processor, the execution status information with the respective unique identifier and respective operation.

12. The method of claim 11, further comprising:
monitoring a respective system status for the respective operation; and
automatically executing management operations based on a time period associated with the respective operation.

13. The method of claim 11, further comprising instantiating, by the at least one processor, an abstraction layer, wherein the abstraction layer is accessible via API or user interface, and the abstraction layer is configured perform operations to manage the communication, match the data operations, translate the messages and/or the matched data operations, associate the respective unique identifier, communicate the translated messages, receive the execution status, and associate the execution status information with the respective unique identifier.

14. The method of claim 11, further comprising matching states to instrument inventory based on execution acknowledgements received from the controller subsystem.

15. The system of claim 14, further comprising:
defining a first communication channel having a first format; and
associating the first communication channel with a respective user and/or trading subsystem.

16. The system of claim 15, further comprising mapping a plurality of message fields of the first communication channel to a communication protocol associated with the settlement and exchange subsystem.

17. The method of claim 11, further comprising matching states to data operations and data targets managed by the data controller subsystem based on execution acknowledgements received from the data controller subsystem.

18. The method of claim 17, further comprising:
defining a first communication channel having a first format; and
associating the first communication channel with a respective user and/or user subsystem.

19. The method of claim 18, further comprising mapping a plurality of message fields of the first communication channel to a communication protocol associated with the data controller subsystem.

20. The method of claim 11, further comprising operating in a selectable passthrough mode and enhanced security mode, wherein the passthrough mode accepts a unique identifier from a respective user subsystem as part of a data request and links the unique identifier to the data request to subsequent operations executed without the unique identifier, including any aggregated data requests communicated to the data controller subsystem; and wherein the enhanced security mode uses an obscured identifier for respective data requests, limiting any compromise of data beyond the data target to the obscured identifier.
